(19) United States
(12) Patent Application Publication
(10) Pub. No.: US 2018/0095751 A1
(43) Pub. Date: Apr. 5, 2018

(54) PLACEMENT OF A CALCULATION TASK ON A FUNCTIONALLY ASYMMETRIC PROCESSOR

(71) Applicant: COMMISSARIAT A L'ENERGIE ATOMIQUE ET AUX ENERGIES AL TERNATIVES, PARIS (FR)

(72) Inventors: Alexandre AMINOT, PARIS (FR); Yves LHUILLIER, BURES-SUR-YVETTE (FR); Andrea CASTAGNETTI, PARIS (FR); Alain CHATEIGNER, NANTES (FR); Henri-Pierre CHARLES, GRENOBLE (FR)

(21) Appl. No.: 15/567,067

(22) PCT Filed: Mar. 14, 2016
(86) PCT No.: PCT/EP2016/055401

§ 371 Date: Oct. 16, 2017

(30) Foreign Application Priority Data
Apr. 20, 2015 (FR) 1553478

(51) Int. Cl. G06F 9/30; G06F 15/80; G06F 9/48

(52) U.S. Cl. CPC G06F 9/30014; G06F 9/30021; G06F 9/30083; G06F 9/4893; G06F 9/30101; G06F 15/80; G06F 9/3017

(57) ABSTRACT

A method for managing a calculation task on a functionally asymmetric multicore processor, at least one core of the processor associated with one or more hardware extensions, comprises the steps of receiving a calculation task associated with instructions that can be executed by a hardware extension; receiving calibration data associated with the hardware extension; and determining an opportunity cost of execution of the calculation task as a function of the calibration data. Developments describe the determination of the calibration data in particular by counting or by computation (on line and/or off line) of the classes of the instructions executed, the execution of a predefined set of instructions representative of the execution room of the extension, the inclusion of energy and temperature aspects, the translation or the emulation of instructions or the placement of calculation tasks on the different cores. System and software aspects are described.

### FIELD OF THE INVENTION

The invention relates to multicore processors in general and the management of the placement of calculation tasks on functionally asymmetric multicore processors in particular.

### STATE OF THE ART

A multicore processor can comprise one or more hardware extensions, intended to accelerate parts of software codes that are very specific and difficult to parallelize. For example, these hardware extensions can comprise circuits for floating point computation or vector computation.

A multicore processor is called “functionally asymmetric” when certain extensions lack certain processor cores, that is to say when at least one core of the multicore processor does not have the hardware extension required for the execution of a given instruction set. There is an instruction set common to all the cores and a specific instruction set which can be executed only by certain predefined cores. By uniting all the instruction sets of the cores that make up the multicore processor, all the instructions (of the application) are represented. A functionally asymmetric processor can be characterized by an unequal distribution (or association) of the extensions on the processor cores.

The management of a functionally asymmetric multicore processor poses a number of technical problems. One of these technical problems consists in effectively managing the placement of the calculation tasks on the different processor cores.

The software applications use these hardware extension in a dynamic way, that is to say which varies over time. For one and the same application, certain calculation phases will use a given extension almost at full load (e.g. calculations on data of floating point type) whereas other calculation phases will use it little or not at all (e.g. calculations on data of integer type). Using an extension is not always efficient in terms of performance or energy (“quality” of use).

The works published concerning the placement of calculation tasks on functionally asymmetric multicore processors do not describe satisfactory solutions.

The patent document WO2013101139 entitle “PROVIDING AN ASYMMETRIC MULTICORE PROCESSOR SYSTEM TRANSPARENTLY TO AN OPERATING SYSTEM” discloses a system comprising a multicore processor with several groups of cores. The second group can have an instruction set architecture (ISA) different from the first group, or even come under the same ISA architecture but with different support power and performance level. The processor also comprises a migration unit which processes the migration requests for a certain number of different scenarios and provokes a change of context to dynamically migrate a process from a second core to a first core of the first group. This dynamic change of hardware context can be transparent for the operating system.

This approach comprises limitations for example in terms of flexibility of placement and of dependency on the instruction set. There is a need for methods and systems for managing calculation tasks on functionally asymmetric multicore processors, the processor cores being associated with one or more hardware extensions.

### SUMMARY OF THE INVENTION

The present invention relates to a method for managing a calculation task on a functionally asymmetric multicore processor, at least one core of said processor being associated with one or more hardware extensions, the method comprising the steps consisting in receiving a calculation task associated with instructions that can be executed by a hardware extension; receiving calibration data associated with the hardware extension; and determining an opportunity cost of execution of the calculation task as a function of the calibration data. Developments describe the determination of the calibration data in particular by counting or by computation (on line and/or off line) of the classes of the instructions executed, the execution of a predefined set of instructions representative of the execution room of the extension, the inclusion of energy and temperature aspects, the translation or the emulation of instructions or the placement of calculation tasks on the different cores. System and software aspects are described.

According to one embodiment, the invention is implemented at the hardware level and at the operating system level. The invention recovers and analyzes certain information from the last execution quanta (times allotted by the scheduler to the task on a core) and thus estimates the cost of the future task placement on different types of cores.

Advantageously according to the invention, the task placement is flexible and transparent for the user.

Advantageously, the method according to the invention performs the placement of the calculation tasks as a function of objectives that are more diversified and global than the solutions known from the prior art which confine themselves to only the instructions associated with the calculation tasks. In effect, according to the known solutions, the placement of the calculation tasks involving the switching on or the switching off of one or more cores is performed by considering only the “strict” use of the extension. In effect, a core with no extensions cannot execute instructions targeting one or more particular extensions. Consequently, the current solutions examine whether an extension is used (e.g. placement of the application on a core with extension) or is not used (e.g. placement on a core without extension). In other words, the known approaches consider the presence of calls for such extensions within the source code but proceed with the placement of the tasks exclusively as a function of the code instructions and ignore in particular any other criterion, in particular energy-related. Other known approaches are based on an analysis of the source code and on the planned use of hardware extensions, proceed with code mutations, but without estimating criteria including for example performance or energy degradation.

Advantageously, the invention can meet the so-called “multi-objective” needs that a task scheduler must satisfy such as a) the performance, b) the energy efficiency and c) the thermal constraints (“dark-silicon”). Some embodiments make it possible to increase the number of cores of a multicore processor, while keeping performance/energy/surface efficiency. The additional programming effort for its part remains small.

Advantageously according to the invention, the prediction of the costs and of the savings in execution of a given task on each of the different cores of a heterogeneous system can be performed dynamically.

Advantageously, the method according to the invention takes account of dynamic criteria linked to the execution of a program. Currently, the operation of a hardware extension by a software code is dictated either explicitly by the programmer of the code, or performed automatically by the compiler. Since the compilation of software is more often than not done off line, the programmer or the compiler can base the choice of whether or not to operate an extension only on criteria which are linked to the software itself, and not on dynamic criteria on executing the program. Without information on the runtime environment (workload, instantaneous scheduling of tasks, availability of resources), it is generally impossible to determine in advance whether a given hardware extension must or must not be operated. The method according to the invention makes it possible to predict and/or estimate the use of one or more hardware extensions.

Advantageously according to the invention, it becomes possible to implement a dynamic task scheduling and placement strategy, lifting various constraints such as (i) the predictability and interoperability in using constrained heterogeneous systems (functional asymmetry with common base) and (ii) the optimization with respect to overall objectives of the system (e.g. performance, consumption and surface), made possible by means of a rapid, dynamic and transparent prediction of the execution of a given code on a given core.

Advantageously, some embodiments of the invention comprise steps of prediction as to the use of the extensions, which can advantageously optimize the energy efficiency and optimize the computation performance levels. These embodiments can in particular allow the scheduler a certain freedom as to the choice of the cores on which to execute the different program phases.

Advantageously, experimental results have shown that, by no longer being constrained by the instruction set, the dependency on the size of quanta is very reduced. The percentages of time spent on a basic body are very close whatever the quanta size, which makes it possible to be independent of other parameters of the scheduler.

Advantageously, the method according to the invention makes it possible to optimize the energy consumption, including in the case of low use of an extension.

Advantageously, the method according to the invention makes it possible to place a task on a processor, whether this processor is associated with a hardware extension or not, as a function of the implementation of the task (therefore with or without operation of the extension). Consequently, a scheduler can optimize the energy or the performance dynamically without concern for the initial implementation of the task.

Advantageously, the invention makes it possible to predict or determine dynamically the benefit of the use of one or more hardware extensions and of placing the calculation tasks (i.e. allocating these tasks to different processors and/or processor cores) as a function of this prediction.

Advantageously, the method according to the invention makes it possible to delay the decision to use or not use an extension to the execution, gives the programmer a higher level of abstraction and provides the software of the system with increased freedom of decision allowing more optimization in scheduling terms. Once this flexibility is obtained, the quality of the decisions of the system software becomes dependent only on the runtime environment. For this, the system software measures the relevant variables of the runtime environment.

Advantageously, transparently for the programmer and dynamically for the compiler, the method according to the invention makes it possible to have task migration freedoms and accumulated knowledge concerning the runtime environment in order to optimize the placement of calculation tasks on one or more asymmetrically functional multicore processors, and do so as a function of the overall objectives of the scheduler.

Advantageously, the method according to the invention confers freedom of action in terms of placing calculation tasks. Such freedom of action allows the system to migrate the (calculation) tasks to any processor core, and do so despite the different extensions present in each of these cores. The software applications executed on the system are associated with a more continuous and more flexible exploration room to achieve the objectives (or multi-objectives) in terms of power (for example thermal performance levels).

Advantageously, embodiments of the invention will be able to be implemented on “systems-on-chip” (SoC) applications of consumer or embedded electronics type (e.g. telephones, buried components, desktop, Internet of things, etc.). In these fields of application, the use of heterogeneous systems is commonplace for optimizing computation efficiency for a specific workload. With these latter systems continually increasing in complexity (e.g. increase in the number of cores and in the workloads), some embodiments of the invention make it possible to reduce the impact of this increasing complexity, by setting aside the heterogeneity of the systems.

Advantageously, experimental results (mibench benchmarks, SDVBS) have demonstrated performance and energy consumption gains in relation to the system and method known from the prior art.

Advantageously, the method according to the invention allows a dynamic optimization of the performance and of the energy by virtue of the estimator of the degradation and of the prediction unit.

Advantageously, the scalability of the multicore processors is enhanced. In particular, the management of the asymmetry of the platform is performed transparently for the user, that is to say does not increase the software development effort or constraints.

Advantageously, an optimization of the scheduling makes it possible to better address the technical issues which increase with the number of cores such as reducing the surface area and the energy consumed, the priority of the tasks, the dark-silicon (temperature).

Advantageously, the placement/scheduling of the tasks according to the invention is flexible. Moreover, the scheduling is performed optimally and transparently for the user.

Advantageously, compared to the known solutions, the method according to the invention provides the use of prediction units (“predictors”) and/or estimators of interest, allowing an optimized task placement.

The known approaches which monitor the execution of the programs and try to optimize the placement of the calculation tasks are generally interested only in the internal differences of one and the same processor (e.g. “in-order/out-of-order”, difference of frequencies, etc.) and cannot be applied to the hardware extensions themselves (the data, models and constraints are different).

Advantageously according to the invention, the dependency on the instruction set is reduced, even eliminated. The advantages comprise in particular an enhanced efficiency in energy and performance terms. The use of an extension does not always provide performance and energy gains. For example, a computation phase with a low use of an extension makes it possible to speed up the calculations (compared to an execution conducted on a core without extension) but the energy consumption may be increased because of the static energy of the extension (not offset by the gain in execution time). Similarly, in terms of performance, the compiler can use an extension by planning for that to speed up the execution, but, because of the additional memory movement (e.g. between the extension and the registers of the “basic” cores), the performance will in reality be depreciated.

Advantageously, the choice of the placement of the tasks according to the method is flexible. In the current systems, the objective of the operating system is not always to optimize the performance, the objective may be a minimization of the energy consumed or a placement optimizing the temperature of the cores (“dark silicon”). Because of the dependency on the instruction set, the scheduler may be forced to execute an application as a function of its resource requirements and not by considering an overall objective.

Advantageously according to the method, the placement is independent of other parameters supervised by the scheduler. A scheduler generally allocates a time quanta to each calculation task on a processor. If the calculation of a task is not completed, another quanta will be associated with it. The size of these quanta is variable so as to allow for a fair and optimized sharing of the task differences between the different processors (typically between 0.1 and 100 ms). The dimensioning of the quanta involves a more or less fine detection of the phases of basic type. There can be edge effects (for example, incessant migrations). Taking only these edge effects into account ultimately reduces the flexibility of placement and the optimizations.

### DESCRIPTION OF THE FIGURES

Different aspects and advantages of the invention will emerge based on the description of a preferred, but nonlimiting, mode of implementation of the invention, with reference to the figures below:

FIG. 1 illustrates examples of processor architectures;

FIGS. 2A and 2B illustrate certain aspects of the invention in terms of energy efficiency, depending on whether hardware extensions are or are not used;

FIG. 3 illustrates examples of architectures and of placement of the tasks;

FIG. 4 provides examples of steps of the method according to the invention.

### DETAILED DESCRIPTION OF THE INVENTION

The invention generally allows an optimized placement of calculation tasks on a functionally asymmetric multicore processor. A functionally asymmetric multicore processor comprises programmable elements or processor cores, using more or less full functionalities.

A “full” core (i.e. a core with one or more hardware extensions) is a “basic” core (i.e. a core without hardware extension) augmented by one or more hardware extensions.

A “hardware extension” or “extension” is a circuit such as a floating point calculation unit FPU, a vectored calculation unit, an SIMD, a cryptographic processing unit, a signal processing unit, etc. A hardware extension introduces a specialized hardware circuit that is accessible or linked to a processor core, which circuit provides high performance levels for the specific calculation tasks. These specific circuits improve the performance levels and the energy efficiency of a core for particular computations, but their intensive use may lead to a reduction of performance in terms of watts per unit of surface area. These hardware extensions associated with the processor core are provided with an instruction set which extends the standard or default instruction set (ISA). The hardware extensions are generally well integrated in the pipeline of the core, which makes it possible to efficiently access the functions by instructions added to the “basic” set (by comparison, a specialized “coprocessor” generally requires instructions allied with specific protocols).

A computation task (or “thread”) comprises instructions, which can be grouped together in instruction sequences (temporally) or into sets or classes of instructions (by nature). The expression “computation task” (or “task”) denotes a “thread”. Other names include expressions like “light processor”, “processing unit”, “execution unit”, “instruction thread”, “lightened process” or “exetron”. The expression denotes the execution of a set of instructions of the machine language of a processor. From the point of view of the user, these executions seem to run in parallel. However, where each process has its own virtual memory, the threads of one and the same process share the virtual memory. By contrast, all the threads have their own call stack. A computation task does not necessarily use a hardware extension: in the commonest case, a computation task is executed by using instructions common to all the processor cores. A computation task can (optionally) be executed by a hardware extension (which nevertheless requires the associated core to “decode” the instructions).

The function of a hardware extension is to speed up the processing of a specific instruction set: a hardware extension can not speed up the processing of another type of instruction (e.g. floating point versus integer).

A processor core can be associated with no (i.e. zero) or one or more hardware extensions. These hardware extensions are then “exclusive” to it (a given hardware extension cannot be accessed from a third-party core). In some architectures, the processor core comprises the hardware extension or extensions. In other architectures, the physical circuits of a hardware extension may encompass a processor core. A processor core is a set of physical circuits capable of executing programs “autonomously”. A hardware extension is capable of executing a part of program but is not “autonomous” (it requires the association with at least one processor core).

A processor core can have all the hardware extensions required to execute instructions contained in a given task. A processor core can also not necessarily have all the hardware extensions required for the execution of the instructions included in the calculation task: the technical problem of displacement and/or of emulation (i.e. of the functionality or of the instruction)—and the associated costs—arises. The hardware extensions can be of different natures. An extension can process an instruction set which is specific to it.

A hardware extension is generally costly in circuit surface area and static energy terms. An asymmetric platform, compared to a symmetric processor, reduces the cost in surface area and in energy, by reducing, on the one hand, the number of extensions and, on the other hand, by switching on or switching off cores containing extensions only when necessary or advantageous.

Regarding the nature of the association between the processor cores and the hardware extensions: in one embodiment, a processor core exclusively accesses one or more hardware extensions which are dedicated to it. In another embodiment, an extension can be “shared” between several processor cores. In these different configurations, the computation load has to be distributed as best it can be. For example, it is advantageous not to overload an extension which would be shared.

The operating system, through the scheduler, provides time quanta, each time quantum being allocated to a given software application. According to one embodiment of the invention, the scheduler is of preemptive type (i.e. the time quanta are imposed on the software applications).

A method (implemented by computer) is disclosed for managing a calculation task on a functionally asymmetric multicore processor, at least one core of said processor being associated with one or more hardware extensions, the method comprising the steps consisting in receiving a calculation task, said calculation task being associated with instructions that can be executed by a hardware extension associated with the multicore processor; receiving calibration data associated with said hardware extension; and determining an opportunity cost of execution of the calculation task as a function of the calibration data.

One or more opportunity costs of execution can be determined. At least one processor core out of the plurality of the cores is thus characterized by an opportunity cost of execution of the calculation task received.

The method according to the invention considers placement “opportunities”, i.e. possibilities or potentialities, which are analyzed.

In a development, the calculation task comprises instructions associated with one or more predefined classes of instructions and the hardware extension is associated with one or more predefined classes of instructions, said classes being able to be executed by said extension.

In a development, the calibration data comprise coefficients indicative of a unitary cost of execution per instruction class, said coefficients being determined by comparison between the execution of a predefined instruction set representative of the execution room of said execution on said hardware extension on the one hand and the execution of said predefined instruction set on a processor core without hardware extension on the other hand.

The “predefined instruction set representative of the “execution room” (ER) aims to represent the different possibilities of execution of the instructions, in a more comprehensive manner, i.e. as exhaustively as possible. Regarding the nature of the instructions (i.e. the classes or types of instructions), an exhaustivity can be reached. On the other hand, since the combinatorics of the sequencings of the different instructions are virtually infinite, the representation is necessarily imperfect. It can nevertheless be approached asymptotically. The principle consisting in executing an instruction set makes it possible to determine “control points” of the method according to the invention (e.g. effective calibration data).

Experimentally, a hundred or so “programs” have been conducted, each containing “tests” (unitary executions) and the execution of software applications in real conditions. The unitary tests have targeted executing a small number of control and/or memory instruction types, mainly in floating point mode. Different benchmarks were used (for example MiBench, SDVBS, WCET, fbench, Polybench). The execution of real software applications aimed to represent the main sequencings in terms of execution of instructions. The software applications notably used different data sets.

In one embodiment, each software application can be compiled for a processor core with hardware extension and also compiled for a core without extension. The two binary versions are then executed on the different cores. The difference in terms of execution time is determined as are the number and the nature of the classes of instructions executed. For a fairly large set of applications, it is possible to determine a cloud of points representing the total execution room. Then, it is possible to establish a correlation between the number of instructions associated with each class of instructions and the difference in execution time between cores with or without extension.

To improve the property of the representative nature of the representative room (ER), the number of software applications can be increased. By the use of statistical techniques, this representative nature can be determined (use of random instructions, thresholds, confidence intervals, distribution of the cloud of points, etc.). Then, a minimal (or optimal) number of software applications that have to be executed in real conditions can be determined. By comparing the execution of instructions on a core with extension and on a core without extension, some results have revealed deviations of the order of 10 to 20% between the performance levels as estimated according to the method and the performance levels actually measured. This order of magnitude accounts for the possibility of operational implementation of the invention (and without additional optimization).

In a development, the method further comprises a step consisting in determining a number of uses of each class of instructions associated with the calculation task by said hardware extension.

In a development, the step consisting in determining the number of uses of each class of instructions comprises a step consisting in counting the number of uses of each class of instructions. In one embodiment, the history, i.e. the past, is used to estimate or assess the future.

In a development, the step consisting in determining the number of uses of each class of instructions comprises a step consisting in estimating the number of uses of each class of instructions, in particular from the uses counted in the past. It is also possible to estimate the number of uses from other methods. It is also possible to combine the act of counting and the act of estimating the number of uses of the classes of instructions.

In a development, the opportunity cost of execution is determined by indexed summation per instruction class of the coefficients per instruction class multiplied by the numbers of uses per instruction class. In the present description, the opportunity cost of execution is also sometimes called “degradation” (from the perspective of a loss of performance). Symmetrically, it may also be a matter of “execution gains” (“accelerations” or “benefits” or “enhancements”). The opportunity cost of execution can be determined from the number of uses which are therefore counted effectively and/or estimated as a function of the counting history.

Advantageously, the upstream determination of the “opportunity cost of execution” (specifically defined by the invention) allows effective optimizations conducted downstream (as described herein below). The “opportunity cost of execution” according to the invention therefore corresponds to a “reading grid” specific to the processor and to the management of the calculation tasks, that is to say to the definition of an “intermediate result” (decision aid) subsequently making it possible to conduct management steps that are specific and dependent on this characterization. This perspective is particularly relevant in as much as it makes it possible to effectively control the processor (intermediate aggregates make it possible to improve the controllability of the system). To recap, specifically, the taking into account of the instruction classes and of the number of uses of these instruction classes allows for the determination of said “opportunity cost of execution”.

In a development, the coefficients are determined off line. It is possible to determine the calibration data once and for all (“offline”). For example, the calibration data can be supplied by the constructor of the processor. The calibration data can be present in a configuration file.

In a development, the coefficients are determined on line. The coefficients can be determined during the execution of a program, for example at the “reset” of the platform. In an open system (for example cluster or “Cloud”), whose topology is a priori unknown, it is possible to calibrate each extension on startup and to determine the topology overall.

In a development, the coefficients are determined by multivariate statistical analysis. Different multivariate statistical analysis techniques can be used, possibly combined. Regression (linear) is advantageously rapid. Principal component analysis (PCA) advantageously makes it possible to reduce the number of coefficients. Other techniques that can be used include factorial correspondence analysis (FCA), called factorial analysis, data partitioning (clustering), multidimensional scaling (MDS), the analysis of the similarities between variables, multiple regression analysis, ANOVA variance analysis (bivariate), and its multivariate generalization (multivariate variance analysis), discriminating analysis, canonical correlation analysis, logistical regression (LOGIT model), artificial neural networks, decision trees, structural equation models, joint analysis, etc.

In a development, the calculation task received is associated with a predetermined processor core and the opportunity cost of execution of the calculation task is associated with a processor core other than the predetermined processor core. What would be the cost of execution on the predetermined processor (if appropriate), i.e. what would be the cost of “continuing” execution, is generally (but not mandatorily) considered. In other cases, the other “candidate” cores are taken into consideration (one, several or all of the addressable cores).

In a development, the opportunity cost of execution of the calculation task is determined for at least one processor core other than the predetermined processor core. In a development, all the processor cores are considered each in turn and the optimization of the placement consists in minimizing the opportunity cost of execution (that is to say, for example, in selecting the processor core associated with the lowest or weakest opportunity cost of execution).

In some embodiments, such a “minimum” function can be used. In other embodiments, specific algorithms (sequence of steps) and/or analytical functions and/or heuristic functions can be used (for example, the candidate cores can be compared in pairs and/or sampled according to various modalities, for example so as to speed up the decision-making placement-wise).

In addition (that is to say entirely optionally) to taking into account the opportunity cost of execution, other criteria can be taken into account to optimize the placement of the calculation task. These criteria can be taken into account additionally (but in some cases can be substituted for the criterion of opportunity cost of execution). These generally complementary criteria can in particular comprise parameters relating to the execution time of the calculation task and/or to the energy cost associated with the execution of the calculation task and/or the temperature (i.e. to the local consequence of the execution considered).

The different costs (opportunities of execution, temperature, energy, performance levels, etc.) can be compared to one another and various arbitration logics can make it possible to select one core in particular by considering these different criteria. Concerning the combinatorial optimization or a multi-objective optimization (some objectives may be antagonistic), various mathematical techniques can be applied. The weighting of these different criteria can in particular be variable and/or configurable. The respective weights allocated to the different placement optimization criteria can for example be configured on line or off line. They can be “static” or “dynamic”. For example, the priority and/or the weight of these different criteria can be variable over time. Analytical functions or algorithms can regulate the different allocations or arbitrations or compromises or priorities between criteria of optimization of the placement of the calculation tasks.

In a development, the determination of the energy cost comprises one or more steps out of the steps consisting in receiving initial indications of use of one or more predefined hardware extensions and/or in receiving energy consumption states (for example DVFS) per processor core and/or in receiving performance asymmetry information and a step consisting in determining an energy optimization of power-gating and/or clock-gating type.

In a development, the method further comprises a step consisting in determining a cost of adaptation of the instructions associated with the calculation task, said step comprising one or more steps out of the steps of translating one or more instructions and/or selecting one or more instruction versions and/or emulating one or more instructions and/or executing one or more instructions in a virtual machine. The adaptation of the instructions becomes necessary if, following the preceding steps, a processor core not having the required hardware extension (core “not equipped”) is determined.

In a development, the method further comprises a step consisting in receiving a parameter and/or a logical scheduling and/or placement rule. This development underscores the different possibilities in terms of “controllability” of the method according to the invention. Logic rules (Boolean expressions, fuzzy logic, rules of practice, etc.) can be received from third-party modules. Factual threshold values also, such as maximum temperatures, execution time bands, etc.

In a development, the method further comprises a step consisting in moving the calculation task from the predetermined processor core to the determined processor core.

In a development, the method further comprises a step consisting in deactivating or switching off one or more processor cores. Deactivating or “cutting the clock signal” or “placing the core in a reduced consumption state” (e.g. reducing the clock frequency) or “switching off” (“dark silicon”).

In a development, the functionally asymmetric multicore processor is a physical processor or a virtual processor. The processor is a tangible or physical processor. The processor can also be a virtual processor, i.e. defined logically. The perimeter can for example be defined by the operating system. A processor can also be determined by a hypervisor.

A computer program product is disclosed, said computer program comprising code instructions making it possible to perform one or more steps of the method, when said program is run on a computer.

A system is disclosed comprising means for implementing one or more steps of the method.

In a development, the system comprises a functionally asymmetric multicore processor, at least one core of said processor being associated with one or more hardware extensions, the system comprising reception means for receiving a calculation task, said calculation task being associated with instructions that can be executed by a hardware extension associated with the multicore processor; reception means for receiving calibration data; and means for determining an opportunity cost of execution of the calculation task as a function of the calibration data.

In a development, the system further comprises means chosen from placement means for placing one or more calculation tasks on one or more cores of the processor; means for counting the use of classes of instructions by a hardware extension, said means comprising software and/or hardware counters; means or registers for saving the runtime context of a calculation task; means for determining the cost of migration and/or the cost of adaptation and/or the energy cost associated with the continuation of the execution of a calculation task on a predefined processor core; means for receiving one or more parameters and/or scheduling rules; means for determining and/or selecting a processor core; means for executing, on a processor core without associated hardware extension, a calculation task planned initially to be executed on a processor comprising one or more hardware extensions; means for moving a calculation task from one processor core to another processor core; and means for deactivating or switching off one or more processor cores.

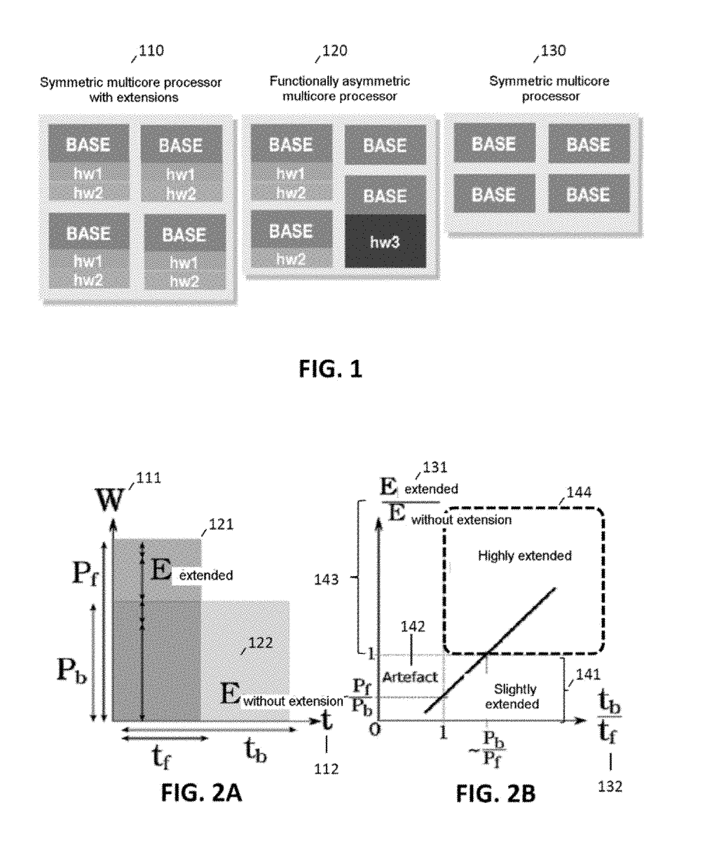

FIG. 1 illustrates examples of processor architectures. A functionally asymmetric multicore processor FAMP 120 is compared to a symmetric multicore processor SMP 110 of which each core contains all the hardware extensions and compared to a symmetrical multicore processor SMP 130 containing only basic cores. The architecture can have shared or distributed memory. The cores can sometimes be linked by an NoC (Network-on-Chip).

An FAMP architecture 120 is close to that of a symmetric multicore processor 130. The memory architecture remains homogeneous, but the functionalities of the cores can be heterogeneous.

As illustrated in the example of FIG. 1, an FAMP architecture 120 can comprise four different types of cores (with the same base). The size of the processor can therefore be reduced. Because of the facility to be able to switch on or switch off the cores, and consequently choose which to switch on as a function of the need of the software application, different optimizations can be performed (energy saving, reduction of the temperature of the cores, etc.).

FIGS. 2A and 2B illustrate certain aspects of the invention in terms of energy efficiency, depending on whether the hardware extensions are used or not.

FIG. 2A refers to a “full” (i.e. with one or more hardware extensions) and “basic” (without hardware extension) processor. The figure illustrates the energy consumed by a processor (surfaces 121 and 122) as a function of the consumed power (“power” on Y axis 111) during a time of execution (time on X axis 112) for one and the same application or thread on the two types of processors. On a “full” processor with an energy power Pf, a calculation task executed for a time tf consumes an energy E_{Full} 121. On a “basic” processor with an energy power P_{b}, a calculation task executed for a time t_{b} consumes E_{Basic} 122. The power P_{f} is greater than the power P_{b} because the hardware extension demands more power. It is commonplace for the execution time t_{b} to be greater than the execution time tf because, not having an extension, a basic processor executes the calculation task less rapidly.

One general objective consists in minimizing the energy consumed, i.e. the area of the surface (shortest possible execution time with minimal power). In the example of FIG. 2A, the processor Full is more efficient. Considering P_{b} and P_{f} as constants, the ratio t_{b}/t_{f} indicates the “acceleration” of the calculation due to the hardware extension.

FIG. 2B illustrates the variation of the energy saving (E_{Basic}/E_{Full}) as a function of the acceleration t_{b}/t_{f}, which indicates the opportunity to use an extended processor with hardware extension(s) rather than without. If the ratio E_{Basic}/E_{Full} is less than 1, that indicates that there is less energy consumed with a processor of Basic type than with an Extended processor (if necessary, this range of operation 141 is called “slightly extended” which reflects the fact that the hardware extension is relatively unused). If the ratio E_{Basic}/E_{Full} is less than 1 and the acceleration ratio t_{b}/t_{f} is less than 1, that reflects a gain both in energy consumed and in computation time performance to the advantage of the processor without hardware extension (this situation can arise in the cases where the extension is badly used). If the ratio E_{Basic}/E_{Full} is greater than 1, the extended processor consumes less energy (section 143 “highly extended”): the extension speeds up the code (i.e. the instructions) and the gains are obtained in terms of energy (this is lower) than in terms of acceleration (faster execution).

It can be noted that when E_{Basic}/E_{Full} equals 1, the ratio t_{b}/t_{f} generally has the value P_{b}/P_{f} (when the processors of basic and extended type consume as much energy, the associated acceleration generally boils down to the ratio of the powers of the processors). When t_{b}/t_{f} equals 1 (when the execution times are the same), E_{Basic}/E_{Full}≈P_{f}/P_{b} (i.e. it is generally observed that the energy and power consumption ratios are generally substantially equal).

The range of operation 144 corresponds to an acceleration of the computations concurrent with a lesser energy consumption, to the benefit of an extended processor with hardware extension. A hardware extension can reduce the energy consumption by reducing the number of steps required to perform specific calculations. When the use of the hardware extension is sufficiently intensive, the acceleration of the calculation on the extension can offset additional power supply required by the extension itself.

Compared to coprocessors, a hardware extension can be more efficient, because of the strong coupling that exists between extension and core. The hardware extensions often share a significant part of the “basic” core and exploit the direct access to the cache memories of L1 and L2 type. This coupling makes it possible in particular to reduce the data transfers and the synchronization complexity.

Even if compilation tools make it possible to maximize the use of a hardware extension, the uses of hardware extensions can remain anecdotal in comparison to the overall load of the processor. A hardware extension generally involves an additional cost in terms of surface and of static energy consumption. An extension often comprises registers of significant size, which can require a more extensive bandwidth and more significant data transfers than those required by the core circuit. If the use of the hardware extension is too low, its specific energy consumption will likely exceed the energy savings targeted because of the hardware acceleration. Worse, an underused hardware extension can cause a reduction in performance of the execution of a software application. For example, in the case of intensive data transfers between the hardware extension and the registers of the core, the excess cost of the memory transfer may cancel out the profit from the acceleration.

A hardware extension is not generally “transparent” for the application developer. Unlike the functionalities of super-scalar type, the developer is often constrained to explicitly manage the extended instruction sets. Consequently, the use of hardware extensions can prove costly compared to the core circuit on its own. For example, the NEON/VFP extension for the ARM processor accounts for approximately 30% of the surface of a processor of Cortex A9 type (without taking into account the caches, and 10% taking the cache L1 into account).

Nevertheless, the hardware extensions are critical and remain necessary to address certain technical problems, particularly in terms of power and performance levels required in certain classes of application (such as, for example, in multimedia, cryptography, image and signal processing applications).

In a symmetric multiprocessor architecture (SMP), in order to keep an instruction set uniform for the different processor cores, extensions have to be implemented in each processor core. This ISA symmetry notably means the use of a significant surface and of a certain energy consumption, which in turn limits the hardware acceleration advantages via extensions.

Advantageously, the method according to the invention makes it possible to (a) asymmetrically distribute the extensions in a multicore processor, (b) know when the use of an extension is “useful” from a performance and energy point of view and (c) move the application over time to different cores, independently of their starting requirement (which is chosen on compilation and therefore not necessarily suited to the context of execution).

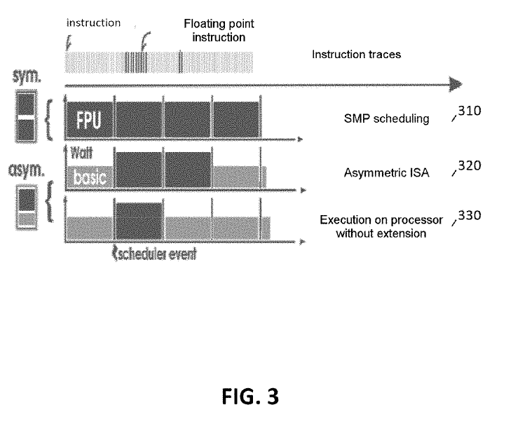

FIG. 3 illustrates examples of architectures and of placement of the tasks. The figure shows examples of task scheduling on an SMP, and two types of scheduling on an FAMP. The unit FPU adds instructions of FP type to an ISA circuit.

In the first case 310 (SMP), each quantum of the task is executed on a processor having an FPU (Floating Point Unit). The first and last quanta happen not to contain FP instructions.

In the second case 320 (“ISA-constrained”), by virtue of the asymmetry of the platform, the first and the last quanta can be executed on a simple core (having no FPU), which reduces the energy consumption during execution. Now, the 3rd quantum contains FP extensions, but not enough to “make the most of” the FP unit.

In the third case 330, the method according to the invention allows the third quantum to be executed on a processor of “basic” type, which makes it possible to optimize the energy consumption to execute this calculation task.

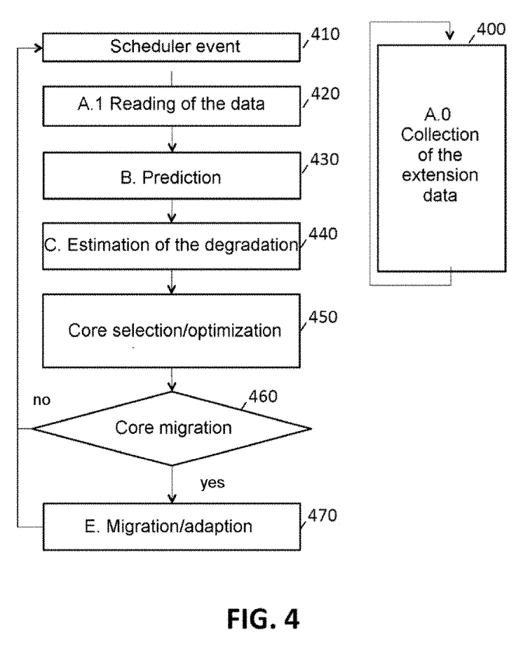

FIG. 4 provides examples of steps of the method according to the invention.

The steps take place in a multicore processor, for which a scheduler carries out the placement of the calculation tasks during the execution of a program.

In the step 400, which proceeds on line and in a loop, the data relating to the use of the hardware extensions are collected (for example by the scheduler). The use of the extensions is monitored (by “monitoring”). In one embodiment, the method for retrieving the data during execution is concentrated only on the instructions intended for the hardware extensions. According to this embodiment, the method is independent of the scheduling process. When the code is executed on a processor with extension (i.e. with one or more extensions), the monitoring can rely on hardware counters. When the code is executed on a processor of “basic” type, the extended instructions are no longer executed natively. For example, if necessary, routines must be added (for example when adapting the code or in the emulation function if applicable) to count the number of instructions of each class of the extension that a processor with extension will have or would have executed. Instead or in addition, the method according to the invention can use software counters and/or hardware counters associated with said software counters.

A “monitoring” system may be execution-heavy. In the context of the invention, the data collected are linked to just the instructions involving extensions, and de facto the slowing down is negligible because it can be done in parallel to the execution. In the context of a processor of “basic” type, the filling of the counters can be done sequentially during the emulation of the functionality accelerated by the other cores, which can add a cost overhead in performance terms. To reduce this cost overhead, it is possible to collect the data periodically, and, if necessary, proceed with an interpolation.

In the step 410, a scheduler event (for example the end of a quantum) is determined, which triggers the step 320.

In the step 420, the collected data are read. For example, the scheduler recovers the data collected by the monitor (A.0) (for example by reading the hardware or software registers).

In the step 420, a prediction is made. Using the recovered data, the prediction system studies the behavior of the application in relation to the use of the extended instruction classes. By analyzing this behavior, it predicts the future behavior of the application. In one embodiment, the prediction is called simple, i.e. is performed reactively, by posing the assumption that the behavior of the application in the next quantum will be similar to the last quantum executed. In one embodiment, the prediction is called “complex” and comprises steps consisting in determining the different types of phases of the program. For example, these types of phases can be determined by saving a behavior history table and by analyzing this history. Signatures can be used. For example, the prediction unit can associate signatures with behaviors executed subsequently. When a signature is detected, the prediction unit can indicate the future behavior, i.e. predict the future operations known and associated with the signature.

In the step 430, a so-called “degradation” estimation is carried out. (“Basic” versus “Full”, i.e. estimation of the degradation of the performance associated with the execution of a calculation task on a processor without hardware extension compared to that executed on a processor with hardware extension). A given task is not tested on each of the processors but an estimation is made, at the moment of scheduling, of the cost that the task would have on different processors. In one embodiment (e.g. off line), all of the code is simulated, by taking into account all the particular features of the processor. This type of approach can not generally be used dynamically (on line). By considering the particular case according to which the process cores all have the same base, all the instructions are executed in the same way in the different cores (for example two cores). Some edge effects can arise between the cores, for example because of cache placements, but these effects remain residual and can be taken into account in the model learning phase.

The estimation of the performance degradation can be performed in different ways.

In a first approach, only the overall percentage of the use of the hardware extension is taken into account. The estimation of the degradation can in fact be based on a model making it possible to calculate said degradation as a function of the percentage of each class of instructions by the extension. However, this approach is not necessarily suitable since different types of instructions can have very different accelerations for one and the same hardware extension.

In a second approach, an estimation of the performance degradation can take account of the instruction classes and take on a form as per:

$$de ion = {\sum }_{i}^{ } ( {NbExecInstr}_{{Class}_{i}} \times {β}_{i} )$$

According to this weighted approach, the values of the weighting coefficients β (“beta”) can be calculated dynamically on line by proceeding with a learning performed by virtue of the execution of several codes on different types of processors. These values can also be calculated off line (and stored in a table that can be read by the scheduler for example).

The calibration data determined from the execution of real calculation tasks make it possible in particular to take into account the emulation cost and the complex evolutions of the beta coefficients. For example, the beta values can be distinguished for a real platform and for a simulated platform.

At runtime (before or during the execution of a calculation task), the beta coefficients are used by the scheduler so as to estimate the performance degradation. The calibration must be reiterated for each implementation of a hardware extension.

The steps of prediction 430 and of estimation of the degradation 440 are chronologically independent.

The degradation can be estimated (440) from predicted data (430). Alternatively, the degradation 440 can be calculated from data recovered in the step 400 and 420, before the prediction 430 is made on the basis of the duly calculated degradation 440. In this particular context, the future degradation is predicted (and not the future instructions of the extensions). The data change but the prediction process remains the same.

In other words, in the step 430, the objective is to “predict” the number of instructions of each class which will be executed at t+1 as a function of the past (of t, t−1 . . . t-n). In the step 440, the objective is to “estimate” the cost of execution at t+1 on the different types of cores. The steps 430 and 440 can be performed in any order because it is possible to independently estimate the cost at the time t on the recovered data and predict the cost at the time t+1 from the cost at the time t.

To put it yet another way, a “prediction” approach consists in a relative determination of the future from the data accessible in the present. An “estimation” allows a determination of the present by means of the data observed in the past. From another perspective, an “estimation” allows the determination of the past in a new context from observations of the past in another context.

According to one implementation of the method of the invention (at “runtime”), a monitoring module captures the calibration data and an analysis module estimates the acceleration associated with the use of an extension. In monitoring terms, the input data must be as close as possible in time to the extended instructions that have to be executed on the next quantum (by making an assumption of continuity, e.g. stable use of a floating point computation unit). A prediction module can then be used. This assumption is realistic when the programs have distinct phases of stable behaviors over sufficiently long time intervals. In the case of more erratic behaviors, more sophisticated prediction modules can be implemented.

In the step 450, a decision step is performed. A decision logic unit for example can take into account the information on the predicted degradation estimation and/or the overall objectives assigned to the platform, the objectives for example comprising objectives in terms of energy reduction, of performance, of priority and of availability of the cores. In other examples, the degradation can also take account of the parameters such as the migration cost and/or the code adaptation cost. In some cases, the migration cost and the cost of the station can be static (e.g. off line learning) or else dynamic (e.g. on line learning or on line temporal monitoring).

In the step 460, there is a migration from one core to another (“core-switching”). The migration techniques implemented can be carried out with the backing up of the context (for example with backup of the registers of the extension in software registers accessible from the emulation).

In the step 470, any adaptation of the code is carried out. For example, to execute code with extensions on a processor of “basic” type, it is possible to use binary adaptation (e.g. by code translation), code multi-version, or even emulation techniques.

The present invention can be implemented from hardware and/or software elements. It can be available as computer program product on a computer-readable medium. The medium can be electronic, magnetic, optical or electromagnetic.

1. A method implemented by computer for managing a calculation task on a functionally asymmetric multicore processor, at least one core of said processor being associated with one or more hardware extensions, the method comprising the steps of:
receiving a calculation task, said calculation task being associated with instructions that can be executed by a hardware extension associated with the multicore processor;
receiving calibration data associated with said hardware extension;
determining an opportunity cost of execution of the calculation task as a function of the calibration data.

2. The method as claimed in claim 1, the calculation task comprising instructions associated with one or more predefined classes of instructions and the hardware extension being associated with one or more predefined classes of instructions, said classes being able to be executed by said extension.

3. The method as claimed in claim 1, the calibration data comprising coefficients indicative of a unitary cost of execution per instruction class, said coefficients being determined by comparison between the execution of a predefined set of instructions representative of the execution room of said extension on said hardware extension on the one hand and the execution of said predefined set of instructions on a processor core without hardware extension on the other hand.

4. The method as claimed in claim 3, further comprising a step of determining a number of uses of each class of instructions associated with the calculation task by said hardware extension.

5. The method as claimed in claim 4, the step of determining the number of uses of each class of instructions comprising a step of counting the number of uses of each class of instructions.

6. The method as claimed in claim the step of determining the number of uses of each class of instructions comprising a step of estimating the number of uses of each class of instructions, in particular from the uses counted in the past.

7. The method as claimed in claim 4, the opportunity cost of execution being determined by indexed summation per class of instructions of the coefficients per class of instructions multiplied by the number of uses per class of instructions.

8. The method as claimed in claim 3, the coefficients being determined off line.

9. The method as claimed in claim 3, the coefficients being determined on line.

10. The method as claimed in claim 3, the coefficients being determined by multivariate statistical analysis.

11. The method as claimed in claim 1, the calculation task received being associated with a predetermined processor core and the opportunity cost of execution of the calculation task being determined for at least one processor core other than the predetermined processor core.

12. The method as claimed in claim 11, further comprising a step of determining a processor core out of the plurality of the cores of the processor for the execution of said calculation task, said step comprising the steps of determining the opportunity cost of execution for all or part of the processor cores of the multicore processor and in minimizing the opportunity cost of execution.

13. The method as claimed in claim 11, further comprising a step of determining a processor core out of the plurality of the cores of the processor for the execution of said calculation task, said determination minimizing the execution time of the calculation task and/or the energy cost and/or the temperature.

14. The method as claimed in claim 13, the determination of the energy cost comprising one or more steps out of the steps of receiving initial indications of one or more predefined hardware extensions and/or in receiving energy consumption states DVFS per processor core and/or in receiving performance asymmetry information and a step of determining an energy optimization of power-gating and/or clock-gating type.

15. The method as claimed in claim 1, further comprising a step of determining a cost of adaptation of the instructions associated with the calculation task, said step comprising one or more steps out of the steps of translating one or more instructions and/or selecting one or more instruction versions and/or emulating one or more instructions and/or executing one or more instructions in a virtual machine.

16. The method as claimed in claim 1, further comprising a step of receiving a parameter and/or a scheduling and/or placement logic rule.

17. The method as claimed in claim 16, further comprising a step of moving the calculation task from the predetermined processor core to the determined processor core.

18. The method as claimed in claim 1, further comprising a step of deactivating or switching off one or more processor cores.

19. The method as claimed in claim 1, the functionally asymmetric multicore processor being a physical processor or a virtual processor.

20. A computer program product, said computer program comprising code instructions making it possible to perform the steps of the method as claimed in claim 1, when said program is run on a computer.

21. A system comprising means for implementing the method as claimed in claim 1.

22. The system as claimed in claim 21, comprising a functionally asymmetric multicore processor, at least one core of said processor being associated with one or more hardware extensions, the system comprising:
reception means for receiving a calculation task, said calculation task being associated with instructions that can be executed by a hardware extension associated with the multicore processor;
reception means for receiving calibration data;
means for determining an opportunity cost of execution of the calculation task as a function of the calibration data.

23. The system as claimed in claim 21, further comprising means chosen from among:
placement means for placing one or more calculation tasks on one or more cores of the processor;
means for counting the use of classes of instructions by a hardware extension, said means comprising software and/or hardware counters;
means or registers for saving the execution context of a calculation task;
means for determining the cost of migration and/or the cost of adaptation and/or the energy cost associated with continuing the execution of a calculation task on a predefined processor core;
means for receiving one or more parameters and/or scheduling rules;
means for determining and/or selecting a processor core;
means for executing, on a processor core without associated hardware extension, a calculation task initially planned to be executed on a processor comprising one or more hardware extensions;
means for moving one calculation task from one processor core to another processor core;
means for deactivating or switching off one or more processor cores.
